(19) United States
(12) Patent Application Publication
(10) Pub. No.: US 2006/0291255 A1
(43) Pub. Date: Dec. 28, 2006

(54) Backlight module with clip for fixing optical films

(75) Inventors: Cheng-Feng Tsai, Miao-Li (TW); Ching-Tung Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/474,640

(22) Filed: Jun. 26, 2006

(30) Foreign Application Priority Data
Jun. 24, 2005 (TW) 94210702

(51) Int. Cl. F21V 17/10; F21V 8/00

(52) U.S. Cl. 362/633; 362/607

(57) ABSTRACT

An exemplary backlight module (2) includes a frame (22) having a plurality of side walls (221), a light guide plate (23) having a light incident surface (231) and a light output surface (233) contained in the frame, at least one optical films (21) disposed adjacent to the light output surface of the light guide plate, and a light source assembly (25) disposed adjacent to the light incident surface of the light guide plate. The frame has at least one elastic fixing clip (225) for fixing the at least one optical films therein. With this configuration, the elastic fixing clip can firmly fix the optical films in the plastic frame. Therefore, the backlight module having the optical films and the plastic frame can be mechanically stable and operate properly.

### FIELD OF THE INVENTION

The present invention relates to backlight modules typically used for liquid crystal display (LCD) devices, and especially to a backlight module with elastic means for fixing optical films therein.

### BACKGROUND

Liquid crystal displays are commonly used as display devices for compact electronic apparatuses, because they not only provide good quality images with little power but also are very thin. The liquid crystals in a liquid crystal display do not emit any light themselves. The liquid crystals have to be lighted by a light source so as to clearly and sharply display text and images. Thus, a backlight module is generally needed for a liquid crystal display.

FIG. 7 is a schematic, exploded view of a conventional backlight module. The backlight module 1 includes two prism films 16, a diffusing film 15, a light guide plate 14, a plastic frame 17, a reflective film 13, and a bottom tray 18 arranged from top to bottom in substantially that order. The light guide plate 14 includes a light incident surface 141, and a light emitting surface 142 adjoining the light incident surface 141. The diffusing film 15 and the prism films 16 are disposed above the light emitting surface 142 of the light guide plate 14. The backlight module 1 further includes a flexible printed circuit (FPC) 12, and three light emitting diodes (LED) 11 electrically connected with the FPC 12. The FPC 12 provides power for the LEDs 11. The LEDs 11 are disposed adjacent to the light incident surface 141 of the light guide plate 14. Light beams emitted by the LEDs 11 enter the light guide plate 14 through the light incident surface 141, and then are emitted from the light emitting surface 142.

The prism films 16 and diffusing film 15 each have corresponding peripheral protrusions (not labeled), which are respectively contained in grooves (not labeled) of the plastic frame 17. Thereby, these optical films 16, 15 are retained in the frame 17. However, the protrusions are not necessarily snugly received in the grooves. The optical films 16, 15 are liable to shift in the frame 17. The backlight module 1 may become loose and unstable, and this may impair the performance of the backlight module 1.

Accordingly, what is needed is a backlight module that can overcome the above-described deficiencies.

### SUMMARY

An exemplary backlight module includes a frame having a plurality of side walls, a light guide plate having a light incident surface and a light output surface contained in the frame, at least one optical films disposed adjacent to the light output surface of the light guide plate, and a light source assembly disposed adjacent to the light incident surface of the light guide plate. The frame has at least one elastic fixing clip for fixing the at least one optical films therein.

With this configuration, the elastic fixing clip can firmly fix the optical films in the plastic frame. Therefore, the backlight module having the optical films and the plastic frame can be mechanically stable and operate properly.

Other advantages and novel features will become more apparent from the following detailed description of preferred embodiments when taken in conjunction with the accompanying drawings. In the drawings, all the views are schematic.

### BRIEF DESCRIPTION OF THE DRAWINGS

FIG. 1 is an exploded, isometric view of a backlight module according to a first embodiment of the present invention.

FIG. 2 is an enlarged view of a circled portion II of FIG. 1.

FIG. 3 is an assembled view of the backlight module of FIG. 1.

FIG. 4 is an enlarged, cross-sectional view taken along line IV-IV of FIG. 3.

FIG. 5 is similar to FIG. 4, but showing part of a backlight module according to a second embodiment of the present invention.

FIG. 6 is similar to FIG. 4, but showing part of a backlight module according to a third embodiment of the present invention.

FIG. 7 is an exploded, isometric view of a conventional backlight module.

### DETAILED DESCRIPTION OF PREFERRED EMBODIMENTS

Reference will now be made to the drawings to describe the preferred embodiments in detail.

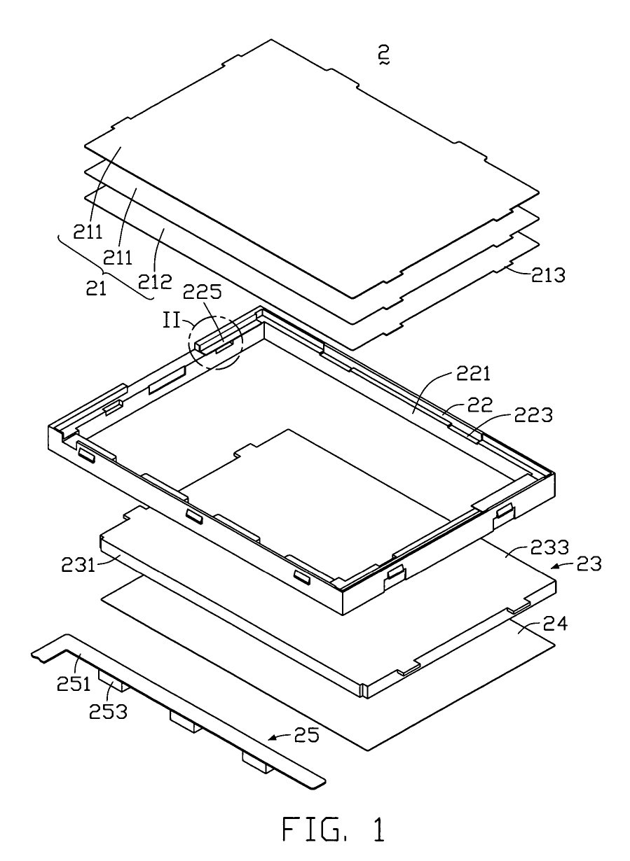

FIG. 1 is an exploded, isometric view of a backlight module 2 according to a first embodiment of the present invention. The backlight module 2 includes a set of optical films 21, a plastic frame 22, a light guide plate 23, a reflective film 24, and a light source assembly 25. The optical films 21, light guide plate 23, and reflective film 24 are arranged in that order from top to bottom in the plastic frame 22.

The optical films 21 include two prism films 211 and a diffusing film 212. The optical films 21 each include a plurality of protrusions 213 at a periphery thereof. For each optical film 21, the protrusions 213 are differently sized such that the optical film 21 can only be received in the plastic frame 22 in a correct orientation. The light guide plate 23 includes a light incident surface 231 and a light output surface 233. The light source assembly 25 includes a flexible printed circuit (FPC) 251, and three light emitting diodes (LED) 253 mechanically and electrically connected to the FPC 251. The FPC 251 is for providing power for the LEDs 253. The plastic frame 22 includes four side walls 221. The side walls 221 include a plurality of grooves 223 corresponding to the protrusions 213 of the optical films 21.

The plastic frame 22 further includes two elastic fixing clips 225 disposed at two opposite of the side walls 221 respectively. Referring also to FIG. 2, the elastic fixing clips 225 are integrally or unitarily formed with the plastic frame 22. Each elastic fixing clip 225 is located above and adjacent a corresponding groove 223. Each elastic fixing clip 225 includes a first elastic portion 2251, a second elastic portion 2252, and a third elastic portion 2253 sequentially connected. The first elastic portion 2251 extends horizontally inwardly from a top peripheral section of the side wall 221 of the plastic frame 22. The second elastic portion 2252 extends vertically down from the first elastic portion 2251. The third elastic portion 2253 extends horizontally inwardly from the second elastic portion 2252, and protrudes beyond an inner face of a main body of the side wall 221. The third elastic portion 2253 can be lifted up slightly, thereby allowing the corresponding protrusion 213 of each optical film 21 to be inserted into the groove 223, so that the optical film 21 is received in the plastic frame 22.

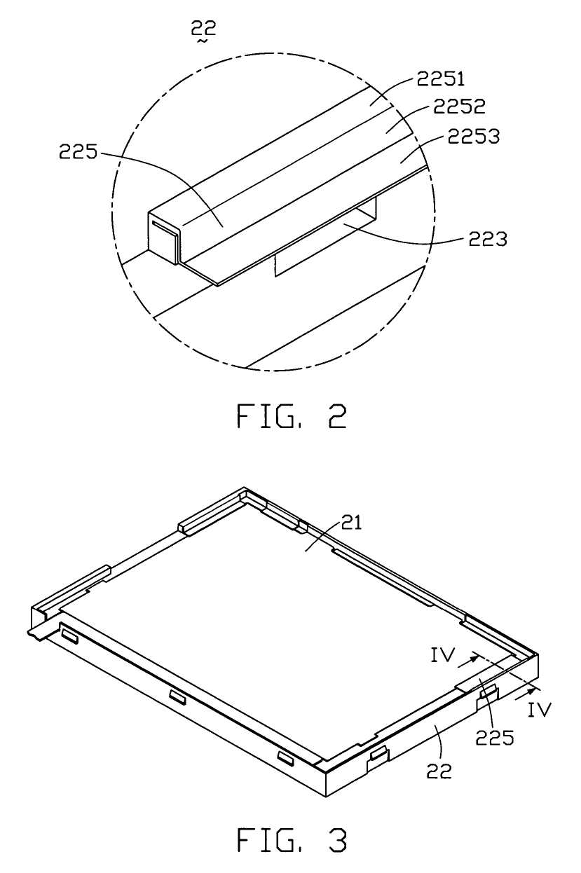

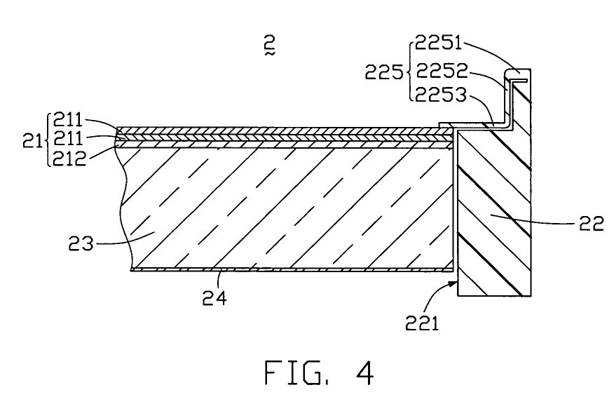

Referring also to FIGS. 3-4, when the backlight module 2 is assembled, the optical films 21, the light guide plate 23, the reflective film 24 and the light source assembly 25 are contained in the plastic frame 22. The LEDs 253 of the light source assembly 25 are located adjacent to the light incident surface 231 of the light guide plate 23. The protrusions 213 of the optical films 21 are contained in the corresponding grooves 223 of the plastic frame 22, and the elastic fixing clips 225 fix the optical films 21 in the plastic frame 22. In particular, prior to assembly, a distance between the third elastic portion 2253 of each elastic fixing clip 225 and the light guide plate 23 is less than a combined thickness of the optical films 21. Therefore once the backlight module 2 is assembled, the third elastic portions 2253 of the elastic fixing clips 225 resiliently press on the optical films 21, thereby fixing the optical films 21 in the plastic frame 22.

With this configuration, the elastic fixing clips 225 can firmly fix the optical films 21 in the plastic frame 22. Therefore the backlight module 2 having the optical films 21 and the plastic frame 22 can be mechanically stable and operate properly.

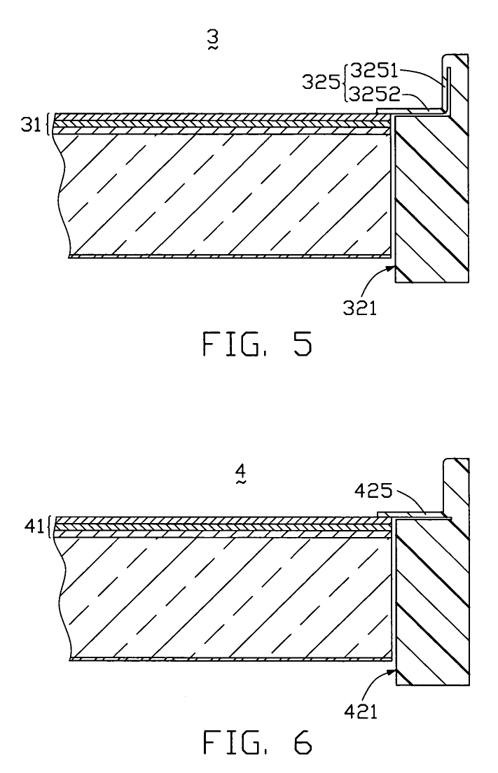

FIG. 5 is a schematic, cross-sectional view of part of a backlight module 3 according to a second embodiment of the present invention. The backlight module 3 has a structure similar to that of the backlight module 2. However, the backlight module 3 includes two elastic fixing clips 325. Each elastic fixing clip 325 is integrally formed with a corresponding one of side walls 321 of a frame (not labeled). Each elastic fixing clip 325 includes a first elastic portion 3251 and a second elastic portion 3252 sequentially connected. The first elastic portion 3251 extends vertically down from an inner top section of the side wall 321. The second elastic portion 3252 extends horizontally inwardly from the first elastic portion 3251. The elastic fixing clips 325 can resiliently press on optical films 31, thereby fixing the optical films 31 in the frame of the backlight module 3.

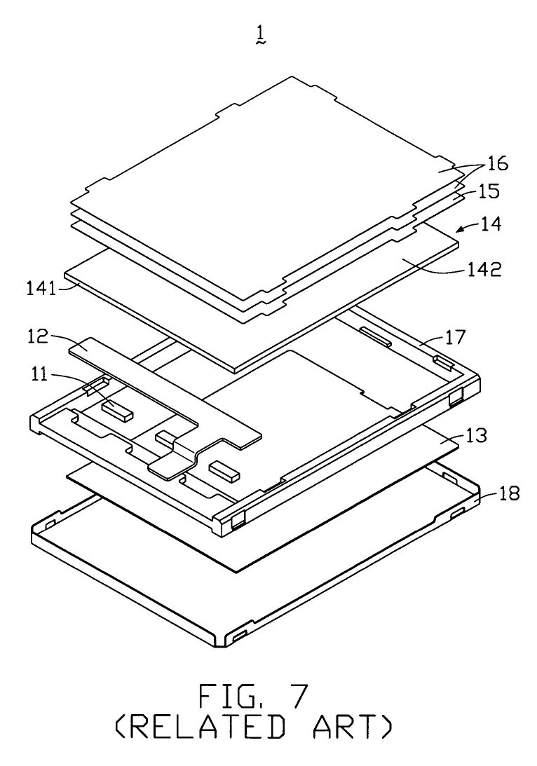

FIG. 6 is a schematic, cross-sectional view of part of a backlight module 4 according to a third embodiment of the present invention. The backlight module 4 has a structure similar to that of the backlight module 3. However, the backlight module 4 includes two elastic fixing clips 425. Each elastic fixing clip 425 is integrally formed with a corresponding one of side walls 421 of a frame (not labeled). Each elastic fixing clip 425 extends horizontally inwardly from an inside section of the side wall 421. The elastic fixing clips 425 can resiliently press on optical films 41, thereby fixing the optical films 41 in the frame of the backlight module 4.

Various modifications and alterations are possible within the ambit of the invention herein. The frame may be made of another kind of elastic material besides plastic; for example, elastic metallic material. The number of elastic fixing clips is not limited to what is described above. That is, the frame can have only one, or three, or more elastic fixing clips at any one or more of the side walls thereof, in order to suitably fix optical films therein.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a frame having a plurality of side walls;
a light guide plate contained in the frame, the light guide plate defining a light incident surface and a light output surface;
at least one optical film disposed adjacent to the light output surface of the light guide plate; and
a light source disposed adjacent to the light incident surface of the light guide plate;
wherein the frame has at least one elastic fixing clip for fixing the at least one optical film therein.

2. The backlight module as claimed in claim 1, wherein the at least one elastic fixing clip is integrally formed with at least one of the side walls of the frame.

3. The backlight module as claimed in claim 2, wherein the at least one elastic fixing clip is two elastic fixing clips disposed at two opposite of the side walls respectively.

4. The backlight module as claimed in claim 3, wherein the at least one optical film defines one or more protrusions at a periphery thereof, and the side walls define one or more grooves corresponding to the protrusions of the at least one optical film.

5. The backlight module as claimed in claim 4, wherein the protrusions of the at least one optical film are received in the grooves of the side walls, so that the at least one optical film is received in the frame.

6. The backlight module as claimed in claim 5, wherein each of the at least one elastic fixing clip is located above and adjacent a corresponding groove of the side walls.

7. The backlight module as claimed in claim 6, wherein the at least one elastic fixing clip resiliently presses on the at least one optical film.

8. The backlight module as claimed in claim 2, wherein the at least one elastic fixing clip comprises a first elastic portion, a second elastic portion, and a third elastic portion.

9. The backlight module as claimed in claim 8, wherein the first, second and third elastic portions are sequentially connected.

10. The backlight module as claimed in claim 9, wherein the first elastic portion extends essentially horizontally inwardly from a top peripheral section of the at least one side wall of the frame.

11. The backlight module as claimed in claim 10, wherein the second elastic portion extends essentially vertically down from the first elastic portion.

12. The backlight module as claimed in claim 11, wherein the third elastic portion extends essentially horizontally inwardly from the second elastic portion, and protrudes beyond an inner face of a main body of the at least one side wall.

13. The backlight module as claimed in claim 2, wherein the at least one elastic fixing clip comprises a first elastic portion and a second elastic portion sequentially connected.

14. The backlight module as claimed in claim 13, wherein the first elastic portion extends essentially vertically down from an inner top section of the at least one side wall, and the second elastic portion extends essentially horizontally inwardly from the first elastic portion.

15. The backlight module as claimed in claim 14, wherein the at least one elastic fixing clip resiliently presses on the at least one optical film.

16. The backlight module as claimed in claim 2, wherein the at least one elastic fixing clip extends essentially horizontally inwardly from an inside section of the at least one side wall.

17. The backlight module as claimed in claim 16, wherein the at least one elastic fixing clip resiliently presses on the at least one optical film.

18. A backlight module, comprising:
a frame having a plurality of side walls;
a light guide plate contained in the frame, the light guide plate defining a light incident surface and a light output surface;
at least one optical film disposed adjacent to the light output surface of the light guide plate; and
a light source disposed adjacent to the light incident surface of the light guide plate;
wherein at least one elastic fixing clip cooperates with the frame to retainably sandwich the at least one optical film therebetween.

19. The backlight module as claimed in claim 18, wherein said optical film defines a protrusion received in a groove of the frame and downwardly pressed by said fixing clip.
